(19) United States
(12) Patent Application Publication
(10) Pub. No.: US 2006/0254852 A1
(43) Pub. Date: Nov. 16, 2006

(54) Integral audio module

(76) Inventor: Yen-Shan Chen, Taoyuan County (TW)

Correspondence Address: BROWDY AND NEIMARK, P.L.L.C.;624 NINTH STREET, NW, SUITE 300, WASHINGTON, DC, 20001-5303, US

(21) Appl. No.: 11/126,287

(22) Filed: May 11, 2005

(51) Int. Cl. H04R 7/00; G10K 13/00

(52) U.S. Cl. 181/160; 181/153

(57) ABSTRACT

An integral audio module includes a housing having a chamber therein and a hole. A diaphragm received in the chamber of the housing to divide the chamber into a front chamber and a rear chamber. The diaphragm has a coil in the rear chamber of the housing. A magnetic assembly is received in the rear chamber to vibrate the diaphragm. The magnetic assembly has a damping chamber with a damping material therein, a first aperture communicating the damping chamber with the rear chamber and a second aperture communicating the damping chamber with outside of the housing.

### BACKGROUND OF THE INVENTION

1. Field of the Invention

The present invention relates generally to an audio device, and more particularly to an integral audio module installed in earphone or hearing aid.

2. Description of the Related Art

FIG. 1 shows a conventional earphone 10, which is consisted of a front casing 11 and a rear casing 12, between which a speaker 20 is provided. A front chamber 13 is formed between the front casing 11 and speaker 20, and a rear chamber 14 is formed between the rear casing 12 and speaker 20. The front casing 11 is provided with a hole 15, and the rear casing 12 is provided with several apertures 16. The speaker 20 has a coil 22 and a wire 21 connected to the coil 22. Elasticity is added to the coil 22 via the wire 21 to provide a magnetic field. The speaker 20 further has a washer 23, a magnet 24 and a yoke 25 that they provide a magnetic field to be interacted with the magnetic field provided by the coil 22 to vibrate a diaphragm 26 for producing audio signals. Some facts of the quality of the audio signals include sizes of the front and rear chamber 11 and 12, sizes and locations of the hole 15 and the apertures 16, and so on. In practice, the speakers are made in a factory, and the casings are made in another factory, and they are assembled in a third factory. The assembling engineers may not know the real characters of the speakers that the earphones may not work normally even through the speakers are no problem in the speakers factory.

### SUMMARY OF THE INVENTION

The primary objective of the present invention is to provide an integral audio module, which the module is made in one place.

According to the objective of the present invention, an integral audio module comprises a housing having a chamber therein and a hole. A diaphragm received in the chamber of the housing to divide the chamber into a front chamber and a rear chamber. The diaphragm has a coil in the rear chamber of the housing. A magnetic assembly is received in the rear chamber to vibrate the diaphragm. The magnetic assembly has a damping chamber with a damping material therein, a first aperture communicating the damping chamber with the rear chamber and a second aperture communicating the damping chamber with outside of the housing.

### BRIEF DESCRIPTION OF THE DRAWINGS

FIG. 1 is a sectional view of the conventional earphone;

FIG. 2 is a sectional view of a first preferred embodiment of the present invention;

FIG. 3 is a sectional view of a second preferred embodiment of the present invention, and FIG. 4 is a sectional view of a third preferred embodiment of the present invention.

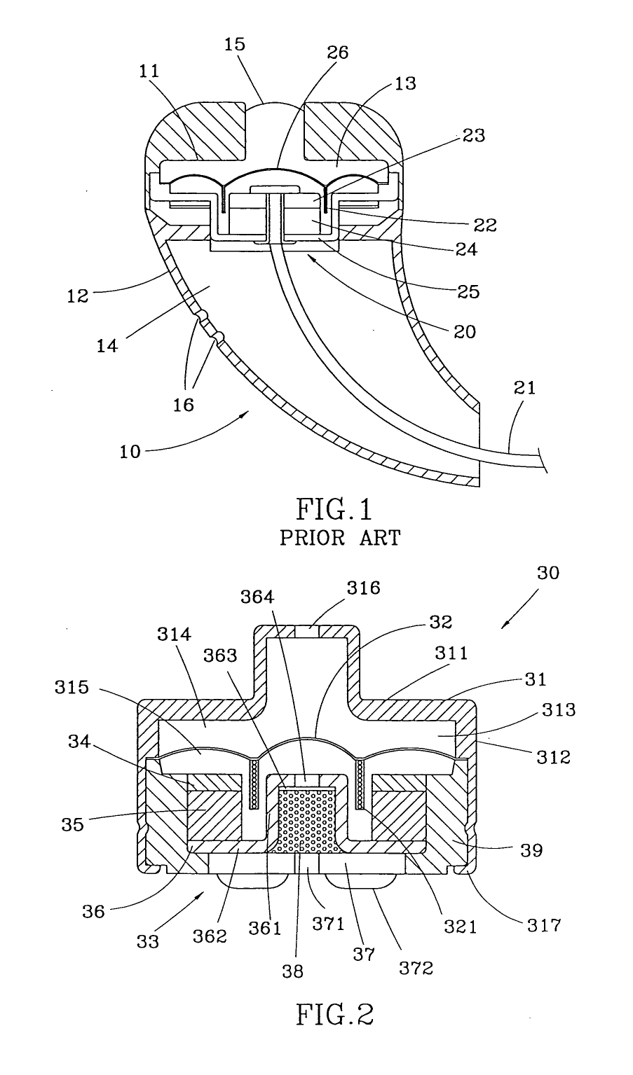

### DETAILED DESCRIPTION OF THE INVENTION

As shown in FIG. 2, an integral audio module 30 of the first preferred embodiment of the present invention comprises:

A housing 31 is consisted of a front wall 311 and a circumferential wall 312. The housing 31 is open at an end opposite to the front wall 311 and has a chamber 313. The front wall 311 has a convex portion at a center thereof, and the convex portion has a hole 316 on a top thereof.

A diaphragm 32 is received in the chamber 313 of the housing 31 to separate the chamber 313 into a front chamber 314 between the first casing 311 and the diaphragm 32 and a rear chamber 314 between the open end of the housing 31 and the diaphragm 32. A coil 321 is provided in the rear chamber 315.

A magnetic assembly 33, which is provided in the rear chamber 315 to vibrate the diaphragm 32, includes a metal ring 34, an annular magnet 35, a yoke 36, a printed circuit board (PCB) 37 and a damping material 38. The metal ring 34 is proximal to the diaphragm 32 and is attached on the magnet 35. The yoke 36 is an iron plate with a convex portion 361 at a center and an annular portion 362 around the convex portion 361. The annular portion 362 is attached on the magnet 35 at a side opposite to the metal ring 34, and the convex portion 361 is received in the metal ring 34 and the magnet 35. The convex portion 361 is hollow to form a damping chamber 363 therein and has a first aperture 364 at a top. The PCB 37 is attached on the yoke 36 opposite to the magnet 35 having a second aperture 371 and pads 372 on a bottom thereof. The damping material 38, which may be foam, is received in the damping chamber 363 to control airflow.

The present invention provides a frame 39, on a top of which the yoke 36, the magnet 35 and the washer 34 are stacked and on a bottom of which the PCB 37 is bonded, such that the magnetic assembly 33 is made. Next, the magnetic assembly 33 is put in the chamber 313 of the housing via the open end. The housing 31 has a plate 317 on an edge of the circumferential wall 312, and they are bent inwards to secure the frame 39. The integral audio module 30 of the present invention is done. The frame may be fixed to the housing by adhesive or other known ways.

The integral audio module of the present invention has three chambers in the housing, they are the front chamber 314, the rear chamber 315 and the damping chamber 363. While the diaphragm 32 is vibrating, it provides a pressure in the rear chamber 315. The pressure is released via the first and second apertures 364, 371 and the damping chamber 363, and is absorbed by the damping material 38 in the damping chamber 363 to make the audio module providing a well audio performance. The integral audio module of the present invention can be made in a single factory to overcome the drawback described in the background.

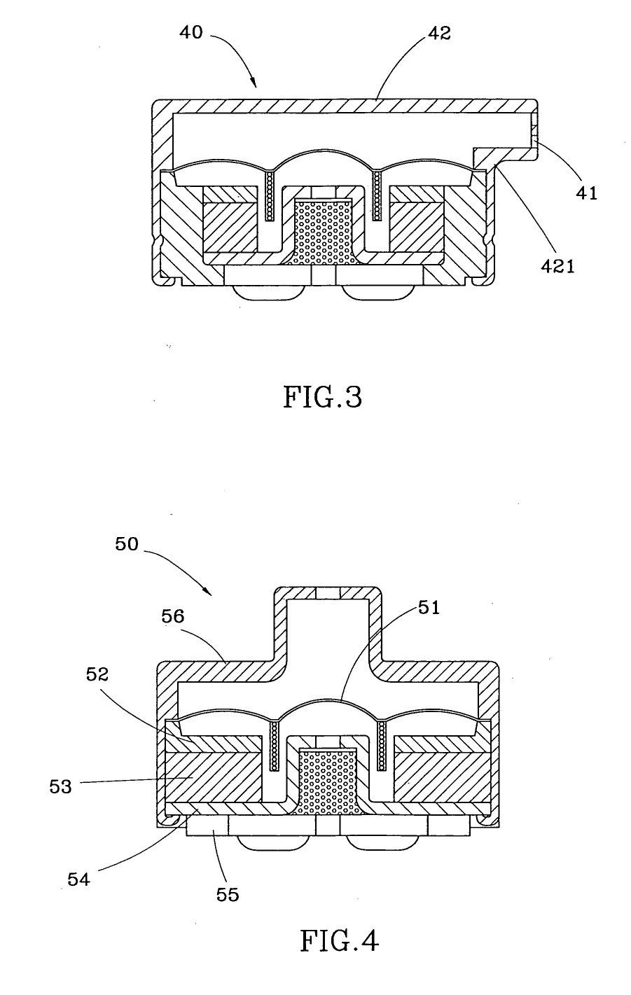

FIG. 3 shows an integral audio module 40 of the second preferred embodiment, which is similar to the integral audio module 30 of the first preferred embodiment, except that the hole 41 is provided at the circumferential wall 421 of the housing 42.

FIG. 4 shows an integral audio module 50 of the third preferred embodiment, which is similar to the integral audio module 30 of the first preferred embodiment except the frame. The integral audio module 50 has a diaphragm 51, a washer 52, a magnet 53, a yoke 54 and a PCB 55 installed in a chamber of a housing 56 and fixed therein by adhesive or other known ways.

What is claimed is:

1. An integral audio module, comprising:
a housing having a front wall, a circumferential wall and a chamber therein;
a diaphragm received in the chamber of the housing to divide the chamber into a front chamber between the front wall and the diaphragm and a rear chamber, which has a coil in the rear chamber of the housing;
wherein the housing has a hole through the front chamber, and
a magnetic assembly received in the rear chamber to vibrate the diaphragm, which has a damping chamber with a damping material therein, a first aperture communicating the damping chamber with the rear chamber and a second aperture communicating the damping chamber with outside of the housing.

2. The integral audio module as defined in claim 1, wherein the magnetic assembly has a yoke with a convex portion at a center and an annular portion around the convex portion, and wherein the damping chamber is formed in the convex portion, and the convex portion is received in the coil with the first aperture at a top thereof.

3. The integral audio module as defined. in claim 2, wherein the magnetic assembly further has a printed circuit board fixed to the yoke, on which the second aperture is provided.

4. The integral audio module as defined in claim 3, wherein the magnetic assembly further has a washer and an annular magnet received in the rear chamber and around the coil.

5. The integral audio module as defined in claim 1, wherein the magnetic assembly is fixed on a frame, and the frame is fixed to the housing.

6. The integral audio module as defined in claim 1, wherein the hole is on the front wall of the housing.

7. The integral audio module as defined in claim 1, wherein the hole is on the circumferential wall of the housing.
